(19) United States
(12) Patent Application Publication
(10) Pub. No.: US 2020/0203775 A1
(43) Pub. Date: Jun. 25, 2020

(54) Button-Type Polymer Lithium Ion Battery and Manufacturing Method Thereof

(71) Applicant: ZHONGSHAN ZHONGWANGDE NEW ENERGY AND TECHNOLOGY CO/. LTD., Zhongshan City, Guangdong (CN)

(72) Inventor: Wei Chen, Zhongshan City, Guangdong (CN)

(21) Appl. No.: 16/313,323

(22) PCT Filed: Apr. 2, 2018
(86) PCT No.: PCT/CN2018/081586

§ 371 Date: Dec. 26, 2018

(30) Foreign Application Priority Data
Feb. 24, 2018 (CN) 201810157232.6

(51) Int. Cl. H01M 10/0587; H01M 10/0525; H01M 2/06; H01M 2/02; H01M 10/04

(52) U.S. Cl. CPC H01M 10/0587; H01M 10/0525; H01M 2/06; H01M 2220/30; H01M 2/0285; H01M 2/0277; H01M 10/0422; H01M 2/0222

(57) ABSTRACT

A button-type polymer lithium ion battery and a manufacturing method thereof. The button-type polymer lithium ion battery of the present disclosure includes a wound electrode, at least two shells and metal conductors. The metal conductors are connected to a cathode and an anode of the wound electrode to form a cathode tab and an anode tab; then, the wound electrode is placed in one of the shells, and the metal conductors can exactly extend to the outside of the shell; and, the remaining shells are spliced, and all the shells are sealed by heat sealing. Compared with the prior art, the wound electrode is higher in charge capacity and easier to manufacture, and the working procedure of welding the electrode inside the shells is omitted.

### FIELD

The present disclosure relates to the technical field of lithium batteries, and in particular to a button-type polymer lithium ion battery. The present disclosure relates to the manufacturing field of lithium ion batteries.

### BACKGROUND

Button batteries are common batteries that are widely applied in various fields. For a conventional button battery, a battery cell needs to be placed in a shell. The shell is a shell having both ends insulated from each other. Then, electrode tabs are welded at both ends of the shell to avoid short circuit between positive and negative electrodes. However, it is difficult to weld the electrode tabs at both ends of the shell, it is likely to result in errors and scraps, and the production is troublesome. Moreover, the conventional button batteries mostly use stacked electrodes, and have a low charge capacity.

### SUMMARY OF THE INVENTION

To solve the above technical problem, an objective of the present disclosure is to provide a button battery which is simpler to manufacture and has a higher charge capacity.

To solve the above problem, the present disclosure employs the following technical solutions.

There is provided a button-type polymer lithium ion battery, comprising:

a housing consisting of more than two shells, a chamber being formed inside the housing;

a wound electrode which is of spiral shape and comprises at least one positive electrode and at least one negative electrode, the wound electrode being disposed within the chamber;

an isolation device which is located between the positive electrode and the negative electrode to avoid the direct contact of the positive electrode with the negative electrode; and

at least two metal conductors, one of which is electrically connected to the at least one positive electrode and the other one of which is electrically connected to the at least one negative electrode, the metal conductors passing through a sidewall of the housing to extend to the outside of the housing.

As a further improvement to the above solution, the shells are made of metal material, and each of the metal conductors is sheathed with an insulation device capable of preventing the metal conductors from coming into contact with the housing.

As a further improvement to the above solution, the shells are made of an aluminum-plastic film.

As a further improvement to the above solution, the insolation device is isolation membrane.

As a further improvement to the above solution, the wound electrode is of cylindrical shape.

As a further improvement to the above solution, the metal conductors are metal foils.

There is further provided a method for manufacturing a button-type polymer lithium ion battery, comprising the following steps of:

a. preparing a positive electrode and a negative electrode, metal conductors with an insulation device, an isolation device and at least two shells on which a groove is formed;

b. electrically connecting at least one of the metal conductors with the insulation device to the positive electrode, and electrically connecting at least one of the metal conductors with the insulation device to the negative electrode;

c. stacking the positive electrode, the isolation device and the negative electrode sequentially in an order of the positive electrode, the isolation device, the negative electrode and the isolation device, and winding by a winding device to obtain a wound electrode;

d. placing the wound electrode into the groove of one of the shells, splicing all the shells, allowing the metal conductors to extend the outside of the shells, and positioning the insulation device between the metal conductors and the shells; and

e. sealing all the shells to obtain a housing, so as to obtain a desired product.

As a further improvement to the above solution, the shells are manufactured by:

a. preparing material of the shells; and

b. stamping the material by a stamping device to obtain more than two shells with a groove, wherein a connecting edge is provided between the shells, all the shells are rotated and spliced in opposite directions to form a housing with a chamber, and there are extended edges on contact surfaces of all the shells.

The present disclosure has the following beneficial effects. The button-type polymer lithium ion battery of the present disclosure includes a wound electrode, at least two shells and metal conductors. The metal conductors are connected to a cathode and an anode of the wound electrode to form a cathode tab and an anode tab; then, the wound electrode is placed in one of the shells, and the metal conductors can exactly extend to the outside of the shell; and, the remaining shells are spliced, and all the shells are sealed by heat sealing. Compared with the prior art, the wound electrode is higher in charge capacity and easier to manufacture, and the working procedure of welding the electrode inside the shells is omitted.

### BRIEF DESCRIPTION OF THE DRAWINGS

The present disclosure will be further described below in detail by specific embodiments with reference to the accompanying drawings.

FIG. 1 is a schematic structural diagram of a wound electrode according to a first embodiment of the present disclosure;

FIG. 2 is a schematic structural diagram after the wound electrode is mounted within a shell according to the first embodiment of the present disclosure;

FIG. 3 is a schematic structural diagram after extended edges of the shells are heat-sealed according to the first embodiment of the present disclosure;

FIG. 4 is a schematic structural diagram of a finished product according to a second embodiment of the present disclosure;

FIG. 5 is a schematic structural diagram of a wound electrode according to the second embodiment of the present disclosure;

FIG. 6 is a schematic structural diagram after the wound electrode is mounted within a shell according to the second embodiment of the present disclosure;

FIG. 7 is a schematic structural diagram after extended edges of the shells are heat-sealed according to the second embodiment of the present disclosure;

FIG. 8 is a schematic structural diagram of a finished product according to the second embodiment of the present disclosure; and

FIG. 9 is a schematic structural diagram of a preferred housing according to the present disclosure.

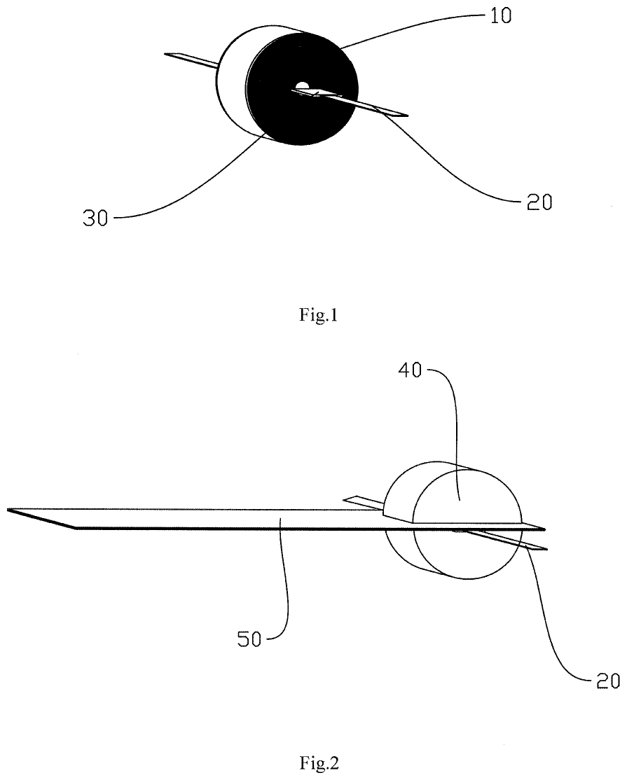

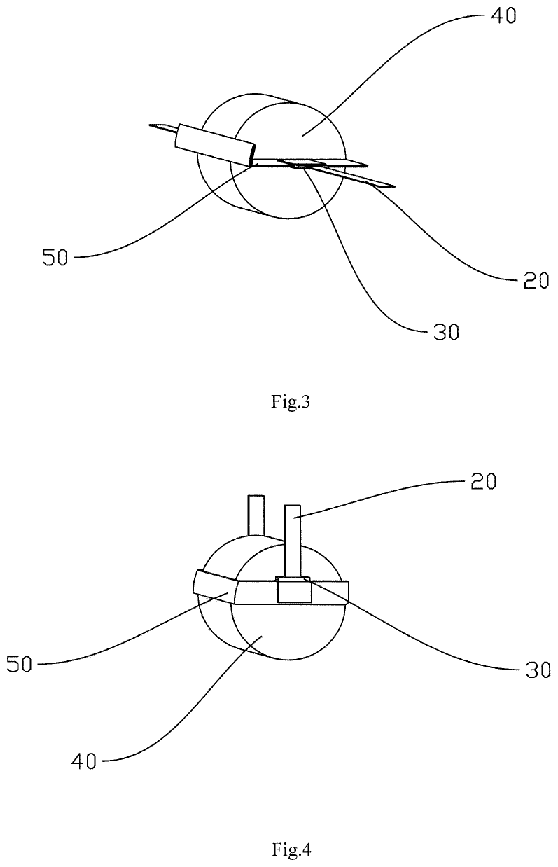

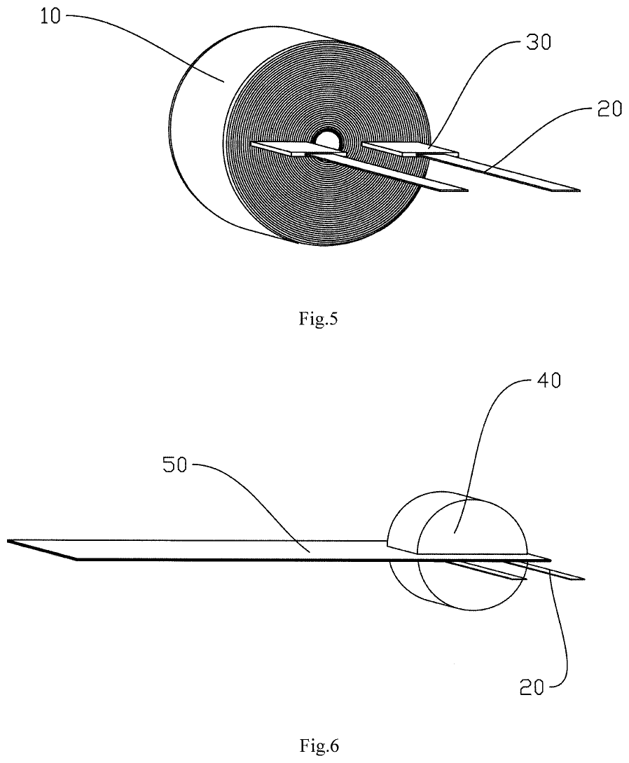

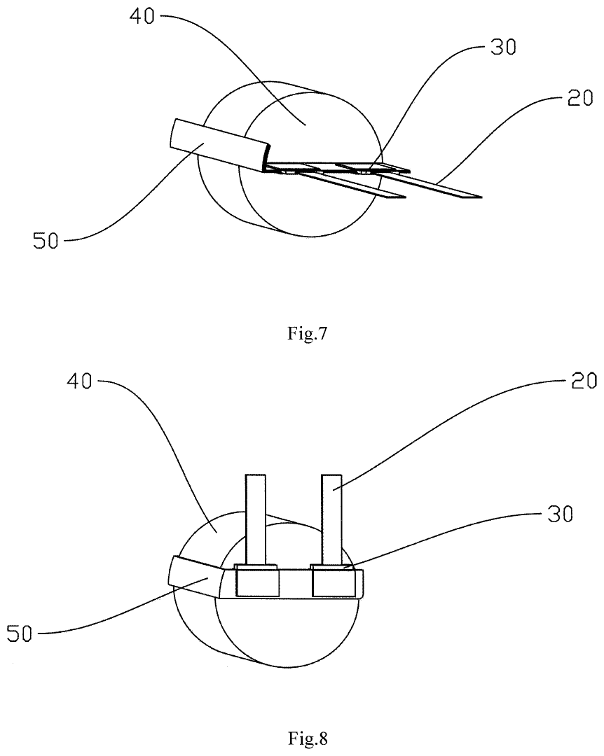

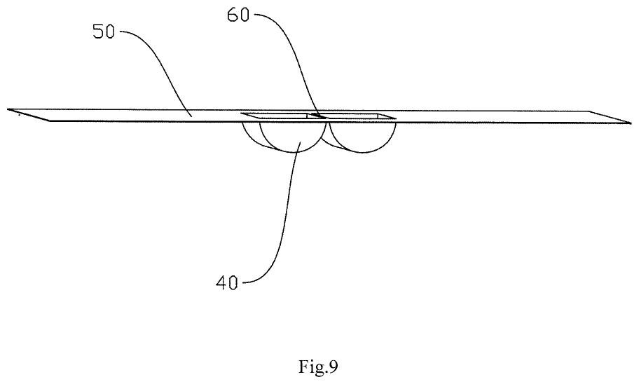

### DETAILED DESCRIPTION OF THE EMBODIMENTS

A button-type polymer lithium ion battery is provided, including: a housing consisting of more than two shells, a chamber being formed inside the housing; a wound electrode 10 which is of spiral shape and includes at least one positive electrode and at least one negative electrode, the wound electrode 10 being disposed within the chamber; an isolation device which is located between the positive electrode and the negative electrode to avoid the direct contact of the positive electrode with the negative electrode, wherein the isolation device is preferably isolation membrane, less preferably isolation frame; and, at least two metal conductors 20, one of which is electrically connected to the at least one positive electrode and the other one of which is electrically connected to the at least one negative electrode, the metal conductors 20 passing through a side face of the housing to extend to the outside of the housing. The metal conductors 20 are connected to the positive electrode and the negative electrode to obtain anode and cathode tabs of the wound electrode 10. The metal conductors 20 are preferably metal foils. The shells 40 may be made of plastics or the like. Considering the strength and usage, the shells 40 are preferably made of metal material. Furthermore, for ease of manufacturing, the shells 40 are most preferably made of an aluminum-plastic film. When the shells 40 are made of metal material, since the anode and cathode tabs cannot be short-circuited, an insulation device 30 capable of preventing the metal conductors 20 from coming into contact with the housing is sheathed on the metal conductors 20, thus preventing the short circuit resulted from the contact of the anode and cathode tabs with the housing. The insulation device 30 is preferably rubber sleeve, and less preferably insulating plastics.

The metal conductors 20 may be connected to the positive electrode and the negative electrode before winding. The connection is preferably welding, and less preferably bolted connection. The wound electrode 10 is preferably cylindrical.

A method for manufacturing a button-type polymer lithium ion battery is provided, including the following steps.

a. Preparing a positive electrode and a negative electrode, metal conductors with an insulation device 30, an isolation device and at least two shells 40 on which a groove is formed.

There are preferably two shells 40. The shells 40 are preferably manufactured by the following method: an aluminum-plastic film is stamped by a stamping device to obtain two shells 40 with a groove, wherein the groove is of semi-cylindrical shape; and, the two shells 40 are connected by a connecting edge 60, and the two shells 40 are rotated and spliced in opposite directions to obtain a housing with a chamber. There are extended edges 50 on contact surfaces of the two shells 40. The extended edges 50 are used for increasing the contact area between the two shells 40, thereby realizing better sealing before splicing.

b. Electrically connecting at least one of metal conductors 20 with the insulation device 30 to the positive electrode.

Electrically connecting at least one of the metal conductors 20 with the insulation device 30 to the negative electrode.

c. Winding the positive electrode, the isolation device and the negative electrode sequentially in an order of the positive electrode, the isolation device, the negative electrode and the isolation device by a winding device to obtain a wound electrode 10.

d. Placing the wound electrode 10 into the groove of one of the shells 40, and splicing all the shells 40, wherein the metal conductors 20 can extend to the outside of the shells 40, and the insulation device 30 is positioned between the metal conductors 20 and the shells 40.

e. Sealing all the shells 40. Preferably, the extended edges 50 between the two shells 40 are heated and pressurized to seal the two shells 40, and the residual extended edges 50 are cut off, folded and encapsulated.

The foregoing description merely shows preferred embodiments of the present disclosure and is not intended to limit the scope of the present disclosure. Any equivalent structural transformations made by using the contents of the description and drawings of the present disclosure or directly or indirectly applied in other related technical fields without departing from the concept of the present disclosure shall fall into the protection scope of the present disclosure.

1. A button-type polymer lithium ion battery, comprising:
a housing consisting of more than two shells, a chamber being formed inside the housing;
a wound electrode which is of spiral shape and comprises at least one positive electrode and at least one negative electrode, the wound electrode being disposed within the chamber;
an isolation device which is located between the positive electrode and the negative electrode to avoid the direct contact of the positive electrode with the negative electrode; and
at least two metal conductors, one of which is electrically connected to the at least one positive electrode and the other one of which is electrically connected to the at least one negative electrode, the metal conductors passing through a sidewall of the housing to extend to the outside of the housing.

2. The button-type polymer lithium ion battery according to claim 1, wherein the shells are made of metal material, and each of the metal conductors is sheathed with an insulation device capable of preventing the metal conductors from coming into contact with the housing.

3. The button-type polymer lithium ion battery according to claim 2, wherein the shells are made of an aluminum-plastic film.

4. The button-type polymer lithium ion battery according to claim 1, wherein the insolation device is isolation membrane.

5. The button-type polymer lithium ion battery according to claim 1, wherein the wound electrode is of cylindrical shape.

6. The button-type polymer lithium ion battery according to claim 1, wherein the metal conductors are metal foils.

7. A method for manufacturing a button-type polymer lithium ion battery, comprising the following steps of:
a. preparing a positive electrode and a negative electrode, metal conductors with an insulation device, an isolation device and at least two shells on which a groove is formed;
b. electrically connecting at least one of the metal conductors with the insulation device to the positive electrode, and electrically connecting at least one of the metal conductors with the insulation device to the negative electrode;
c. stacking the positive electrode, the isolation device and the negative electrode sequentially in an order of the positive electrode, the isolation device, the negative electrode and the isolation device, and winding by a winding device to obtain a wound electrode;
d. placing the wound electrode into the groove of one of the shells, splicing all the shells, allowing the metal conductors to extend the outside of the shells, and positioning the insulation device between the metal conductors and the shells; and
e. sealing all the shells to obtain a housing, so as to obtain a desired product.

8. The method according to claim 7, wherein the shells are manufactured by:
a. preparing material of the shells; and
b. stamping the material by a stamping device to obtain more than two shells with a groove, wherein a connecting edge is provided between the shells, all the shells are rotated and spliced in opposite directions to form a housing with a chamber, and there are extended edges on contact surfaces of all the shells.
